(19) United States
(12) Patent Application Publication
(10) Pub. No.: US 2014/0347586 A1
(43) Pub. Date: Nov. 27, 2014

(54) LIQUID CRYSTAL DISPLAY DEVICE

(71) Applicant: AU OPTRONICS CORP., Hsin-Chu (TW)

(72) Inventors: Chun-Min WANG, Hsin-Chu (TW); Chung-Min SHEN, Hsin-Chu (TW); Jian-Hong LIN, Hsin-Chu (TW)

(73) Assignee: AU OPTRONICS CORP., Hsin-Chu (TW)

(21) Appl. No.: 13/970,718

(22) Filed: Aug. 20, 2013

(30) Foreign Application Priority Data
May 22, 2013 (TW) 102118107

(51) Int. Cl. G02F 1/1339

(52) U.S. Cl. CPC G02F 1/1339
USPC 349/43

(57) ABSTRACT

A liquid crystal display device includes a first substrate, a second substrate, and a plurality of spacers. The first substrate includes a plurality of pixel units, which include at least two gate lines, and two neighboring thin film transistors connected to two gate lines, respectively. The second substrate is opposed to the first substrate. At least one of the spacers overlaps with at least a part of the first thin film transistor and at least a part of the second thin film transistor in a top view.

### FIELD OF THE INVENTION

The present invention relates to a display device, and more particularly to a liquid crystal display device.

### BACKGROUND OF THE INVENTION

A liquid crystal display (LCD) panel includes an array substrate, a color filter substrate, and a liquid crystal layer interposed between the array substrate and the color filter substrate. A plurality of spacers are disposed between two substrates of the liquid crystal panel to maintain a cell gap between the array substrate and the color filter substrate and to sustain external pressure exerted on the substrates. For implementing such construction, a light shielding layer above the spacers is required to shield the randomly scattered light resulting from the uncontrolled liquid crystal molecules around the spacers. The disposition of the light shielding layer above the spacers would reduce light transmission area of pixels. As such, light efficiency of the liquid crystal panel is adversely affected.

Moreover, when the liquid crystal display is unintentionally depressed, the spacers are likely dislocated due to the depression force. Meanwhile, the spacers might scratch and damage the alignment layer disposed on top of the array or color filter substrate, and thus lead to a light leakage problem as the liquid crystal molecules could not be aligned at the scratch damage area.

### SUMMARY OF THE INVENTION

Therefore, the present invention provides a liquid crystal display device with a spacer structure between substrates, whose light transmission rate is improved, and the light leakage problem resulting from depression can be solved.

In accordance with the present invention, the spacer structure is arranged in the pixel area of the liquid crystal display device.

In an embodiment, the present invention provides a liquid crystal display device including a first substrate, a second substrate, and a plurality of spacers interposed between the first and second substrates. The first substrate comprises a plurality of pixel units, which include two gate lines, and two neighboring thin film transistors connected to two gate lines, respectively. The second substrate is opposed to the first substrate. Moreover, at least one of the spacers overlaps with both the first thin film transistor and the second thin film transistor in a top view.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram showing a pixel area of a Half Source Driver liquid crystal display device according to a first embodiment of the present invention;

FIG. 2 is a schematic cross-sectional view of the LCD device of FIG. 1 taken along line A-A′;

FIGS. 3A to 3D are schematic diagrams illustrating a single pixel of the LCD device of FIG. 1 while showing possible spacer shift situations;

FIG. 3E is a plot showing relationship between spacer shift and Spacer Contact Area Ratio;

FIG. 4 is a schematic diagram showing a pixel area of a Half Source Driver liquid crystal display device according to a second embodiment of the present invention;

FIG. 5 is a schematic diagram illustrating an assembly of a color filter substrate and an array substrate in the pixel area of the Half Source Driver liquid crystal display device of FIG. 4;

FIG. 6 is a schematic enlarged diagram of the area C1 of FIG. 5; and

FIG. 7 is a schematic diagram of a spacer area according to an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

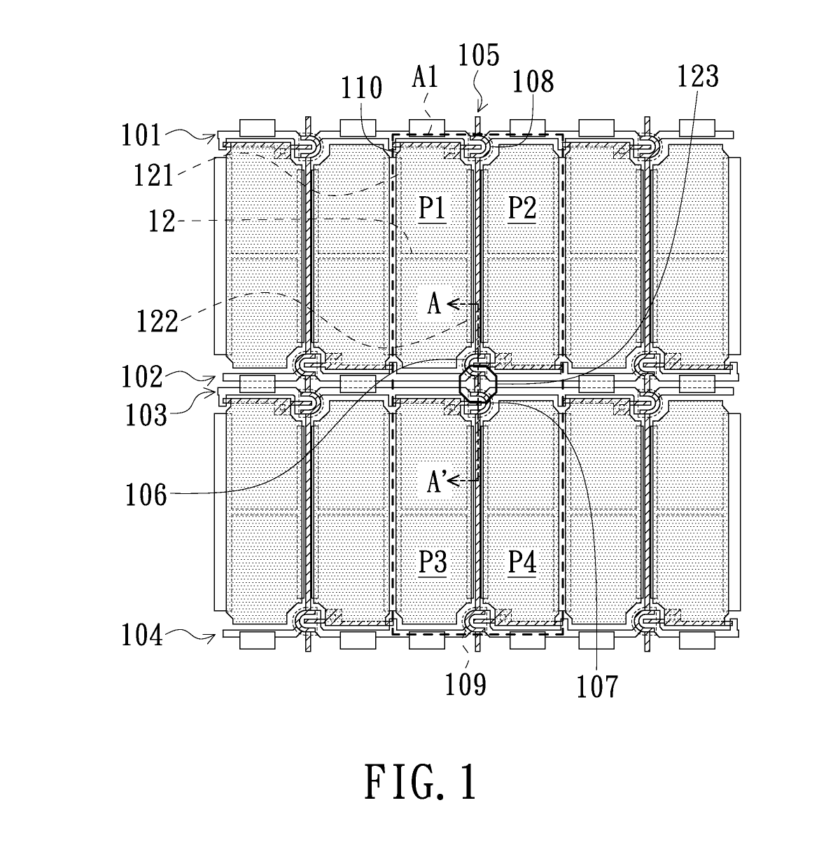

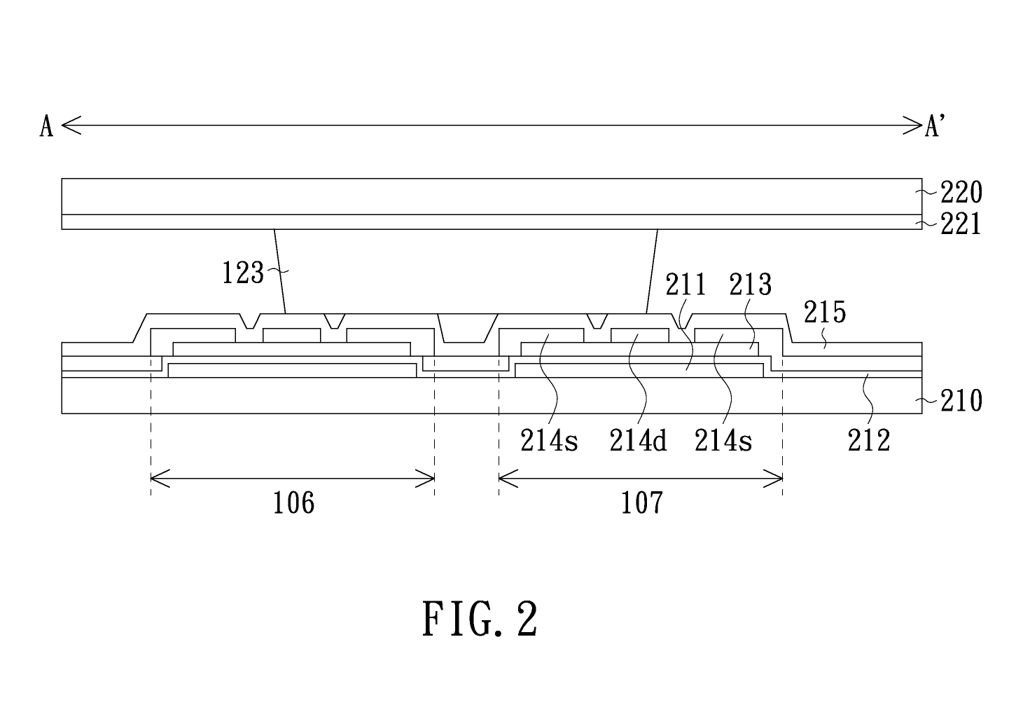

In a first embodiment of this invention, a spacer structure included in a Half Source Driver liquid crystal display is illustrated with reference to FIG. 1, a diagram showing a pixel area of the Half Source Driver LCD device, and FIG. 2, a cross-sectional view of the LCD device of FIG. 1 taken along line A-A′. The area A1 enclosed with the dash line as shown in FIG. 1 is defined as a pixel unit which is composed of four pixels, P1, P2, P3, and P4. These four pixels share a single data line 105 and are respectively driven through a first gate line 101, a second gate line 102, a third gate line 103, and a fourth gate line 104, based on the Half Source Driver structure. The operation of the first pixel P1 is taken as an example. The pixel P1 is disposed on an array substrate and comprises a switch device, which is, for example, a thin film transistor (TFT) 108 as shown in FIG. 1. The TFT 108 is turned on by the gate line 101 first, and then the display signal, or pixel voltage, from the data line 105 is written to the pixel electrode 110 to control the liquid crystal molecules interposed between the array and color filter substrates. The pixel P1 further comprises a common line 12 and its two branches, i.e. a storage capacitor 121 and a storage capacitor 122. Furthermore, the pixel P1 comprises a light shielding layer on the color filter substrate to shield the area where liquid crystal molecules are not under control of the pixel voltage or where there is no pixel electrode disposed (not shown in the drawings). A spacer 123 is disposed between the array and color filter substrates of the LCD panel to maintain the cell gap between the two substrates and sustain the external pressure exerted on the substrates. The spacer is formed of organic material, e.g. a photoresist material, by a photo lithography process.

As shown in FIG. 2, the spacer 123 is located above two thin film transistors 106 and 107 deposited on the array substrate 210. The cross section of the TFT 107 is depicted to illustrate the TFT structure. The TFT 107 comprises a gate electrode 211 formed of metal conductive material, an insulating layer 212 formed of insulating material, a channel layer 213 formed of semiconductor material, a source electrode 214S and a drain electrode 214D formed of metal conductive material, and an insulating layer 215 formed of insulating material. In this embodiment, the thin film transistors are asymmetric TFTs, and the source electrodes and drain electrodes have an arc-like shape with a non-linear edge. The TFTs are also multi-layer structures to support the spacer and maintain the cell gap between the two substrates. In this figure, the spacer 123 is disposed under the light shielding layer 221 deposited on the color filter substrate 220. Therefore, the spacer 123 contacts with the multi-layer spacer-supporting structure at the bottom surface, and with the light shielding layer at upper surface, to maintain the cell gap between the array and color filter substrates.

In this embodiment, the spacer 123 is disposed above two neighboring TFTs and overlaps with at least parts of these two TFTs in a top view. The spacer is supported by the multi-layer structures of TFTs to maintain the cell gap between the two substrates. Therefore, the spacer-supporting structure and spacer at the edge or corner of light transmitting area in the pixel needed in the prior art can be omitted, and thus the light transmitting area in the pixel can be increased. Since the distance between the spacer and the edge of light transmitting area in this embodiment is relatively long, the alignment layer in the light transmitting area can be exempted from damage even if the spacer shifts a distance by the press force.

The overlap area of the spacer and the two neighboring TFTs is controlled by the Spacer Contact Area Ratio, which means a ratio of the contact area of spacer and spacer-supporting structure to the pixel unit area. The LCD panels with different resolution may have the same Spacer Contact Area Ratio. The spacer size may change with the area of the pixel unit, so the spacer may only partially overlap with the TFTs in the top view, or completely overlap with both the TFTs in the top view. In this embodiment, a configuration that the spacer overlaps with parts of the TFTs is given as an example, but it is not limited to such a configuration.

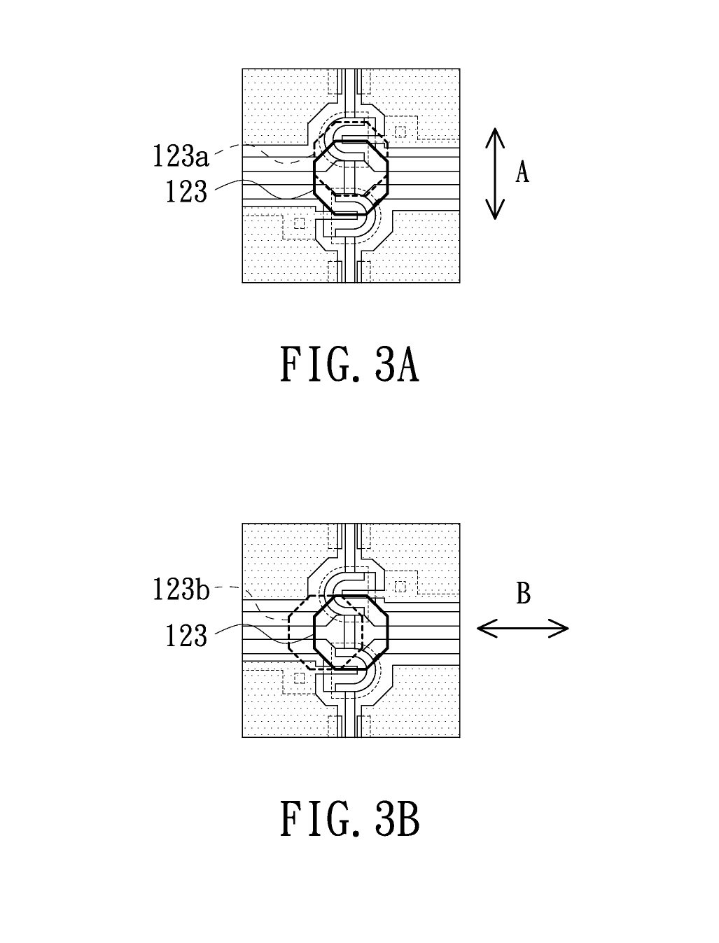

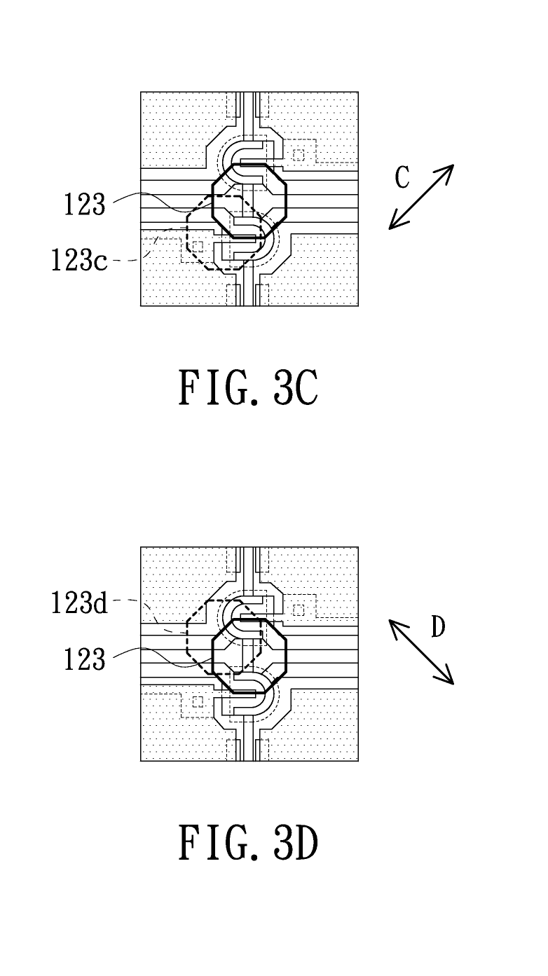

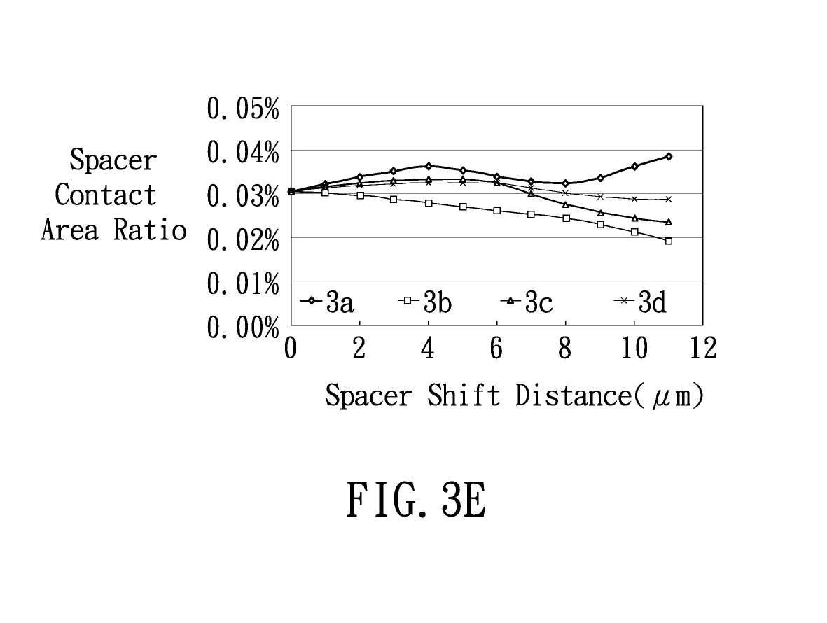

Another advantage of this invention is that the cell gap can be relatively uniform under press force because the two neighboring spacer-supporting structures can compensate the variation of the Spacer Contact Area Ratio. With reference to the examples of spacer shift movement shown in FIGS. 3A, 3B, 3C, and 3D, the spacer 123 shifts to four different directions in the four examples, respectively, due to the press force, and it leads to the decrease of contact area between the spacer and spacer-supporting structures. In FIG. 3A, when the spacer shifts upward, although the contact area between the spacer and the TFT 107 decreases, the neighboring TFT 106 acts as a substitute of the spacer-supporting structure so that the Spacer Contact Area Ratio keeps at substantially the same level. The curve 3a in FIG. 3E shows the Spacer Contact Area Ratio changes when the spacer shifts upward or downward along a direction A. In the curve 3a, as the spacer shifts to a longer distance, 10 μm for example, the Spacer Contact Area Ratio changes within 0.01% as a result of the compensation effect to substitute the spacer-supporting structure. The 0.01% change is significantly ameliorated compared to the Spacer Contact Area Ratio change occurring in the prior spacer-supporting structure design, which is generally as high as 0.1%. Therefore, the LCD panel according to this invention has a relatively uniform cell gap and less mura defect under press force. As mentioned above, if the spacer shifts to a direction as show in FIG. 3B, i.e. shift to right or left along axis B, the result is depicted in the curve 3b of FIG. 3E. In a further example that the spacer shifts to bottom left or top right along axis C, as shown in FIG. 3C, the result is depicted in the curve 3c of FIG. 3E. The curve 3d of FIG. 3E shows the spacer depicted in FIG. 3D, which shifts to top left or bottom right along axis D. According to this invention, the Spacer Contact Area Ratio change can be compensated by the neighboring TFT or spacer-supporting structure, and the Spacer Contact Area Ratio change under press can be limited to only 0.01% level.

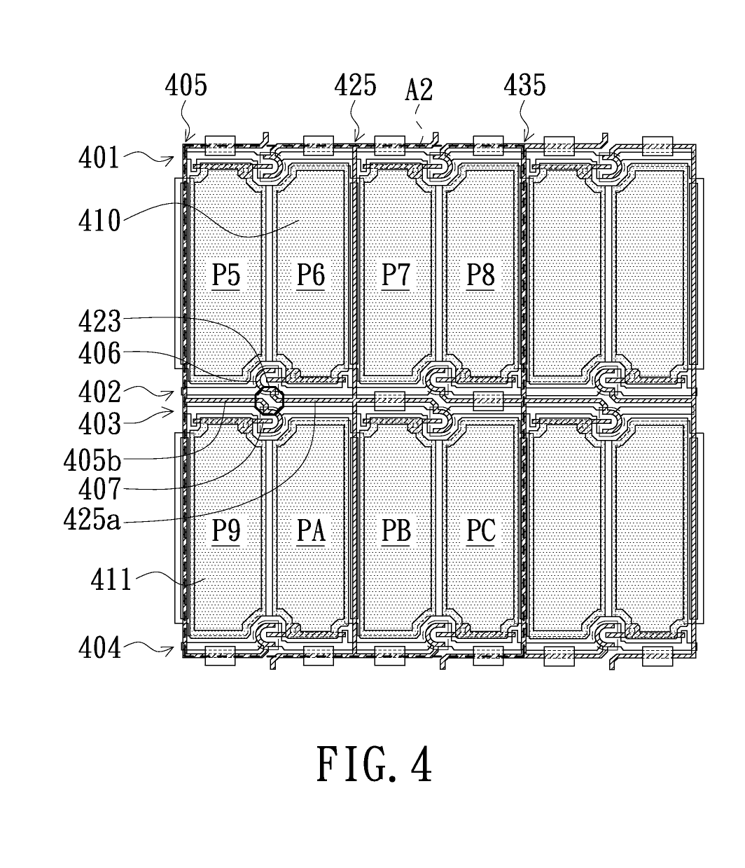

In a second embodiment of this invention, the spacer structure is implemented with another type of Half Source Driver liquid crystal display. As shown in FIG. 4, area A2 enclosed with the dash line is defined as a pixel unit, which is composed of eight pixels, P5, P6, P7, P8, P9, PA, PB, and PC. Based on the Half Source Driver structure, the data signal which is written to pixels P5, P6, PB, and PC is supplied by a data line 425, that written to pixels P9 and PA is supplied by a data line 405, and that written to pixels P7 & P8 is supplied by a data line 435. The eight pixels are driven by a first gate line 401, a second gate line 402, a third gate line 403, and a fourth gate line 404, respectively. Each of the pixels P6 and P9 which are disposed on an array substrate comprises one switch device, TFT 406 or TFT 407. The TFTs 406 and 407 are respectively turned on by the gate lines 402 and 403 first, and then the display signals or pixel voltages from a data line branch 425a of the data line 425 and a data line branch 405b of the data line 405 are written to the pixel electrodes 410 and 411, respectively. The spacer 423 is disposed between the array and color filter substrates and sustain the external pressure exerted on the substrates. The spacer 423 is located above two thin film transistors 406 and 407 deposited on the array substrate. The described TFT usually comprises a gate electrode 211 formed of a metal conductive material, an insulating layer 212 formed of an insulating material, a channel layer 213 formed of a semiconductor material, a source electrode 214S and a drain electrode 214D formed of a metal conductive material, and an insulating layer 215 formed of an insulating material, as shown in FIG. 2. These TFTs are also multi-layer structures to support the spacer and to maintain the cell gap between two substrates. The spacer is disposed under the light shielding layer 221 deposited on the color filter substrate 220. Therefore, the spacer contacts with the multi-layer spacer-supporting structures at the bottom surface, and with the light shielding layer at the upper surface, to maintain the cell gap between the array substrate and the color filter substrate.

Although the pixel layout of the second embodiment is different form the first embodiment, the spacer overlaps with both at least a part of the first TFT and at least a part of the second TFT in a top view to achieve the purpose of increasing the light transmission rate, minimizing light leakage issue and decreasing the Spacer Contact Area Ratio change under a press force.

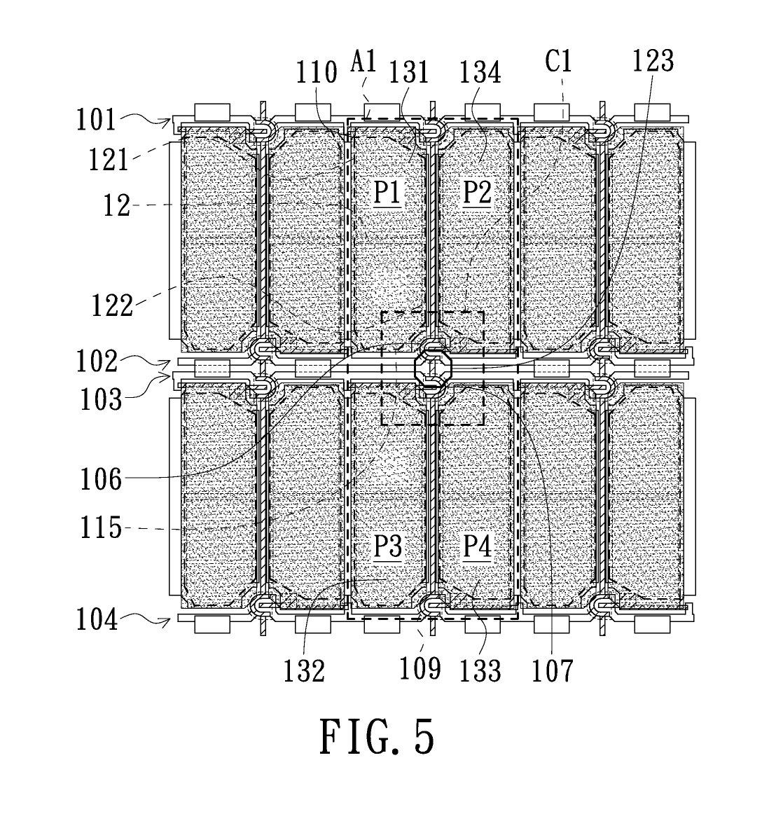

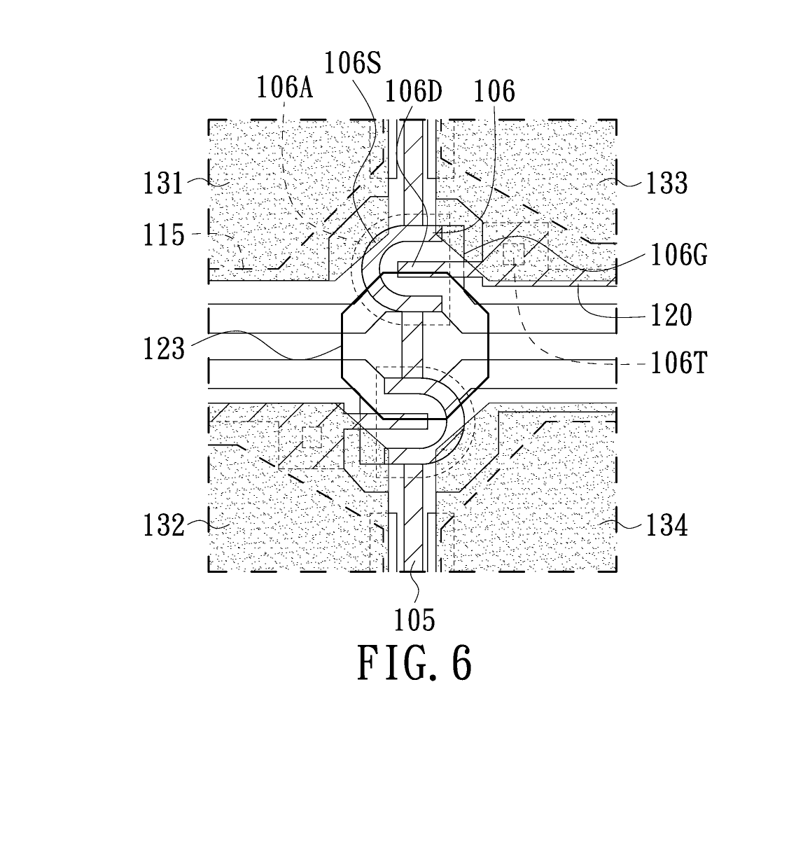

In a third embodiment of this invention, the spacer and the color filter layer structures of the Half Source Driver liquid crystal display are illustrated. As shown in FIG. 5, a schematic diagram of a color filter substrate and an array substrate, the light shielding layer 115 is used to shield the area where liquid crystal molecules are not under control of the pixel voltage, so the light shielding area is required to overlap with the pixel area without pixel electrode, for example, the area of the gate line, the data line, and the thin film transistor. The color filter layer repeats in the order of red, green, and blue along the horizontal direction in FIG. 5. From the schematic diagram of the color filter layer and pixels, the color filter layers cover the light transmission area so the output light from each pixel is transformed to the wavelength corresponding to each color filter layer. The schematic enlarged diagram is represented in FIG. 6 to show the spacer-surrounding area of area C1 in FIG. 5. Area C1 includes parts of four pixels, P1, P2, P3, and P4. The spacer 123 overlaps with both a part of the TFT 106 and a part of the TFT 107 in a top view. TFT 106 is formed of the gate electrode 106G, the insulating layer (not shown in the figure), the channel layer 106A, the source electrode 106S and the drain electrode 106D. The TFT 106 is turned on by a gate signal, and then a data signal from data line 105 is written to the pixel electrode 120 of the pixel P2 through the drain electrode and the contact hole 106T. And the neighboring TFT 107 is functioned to drive the pixel P3. On the color filter substrate side, the light shielding layer 115 is deposited to shield the random light scattered from the uncontrolled liquid crystal molecules, and the color filter layers 131, 132, 133, and 134 are deposited to provide a colorful image. The color filter layers are usually composed of a group of red, green, and blue filter layers, or a group of red, green, blue, and white filter layers. The color group varies in different applications. In this embodiment, the color filter layer is formed in island shapes, and covers the light transmission area of each pixel. The spacer 123 is formed between the adjacent island-shaped color filter layers, and overlaps with both a part of the TFT 106 and a part of the TFT 107 in a top view to maintain the cell gap between the array substrate and the color filter substrate.

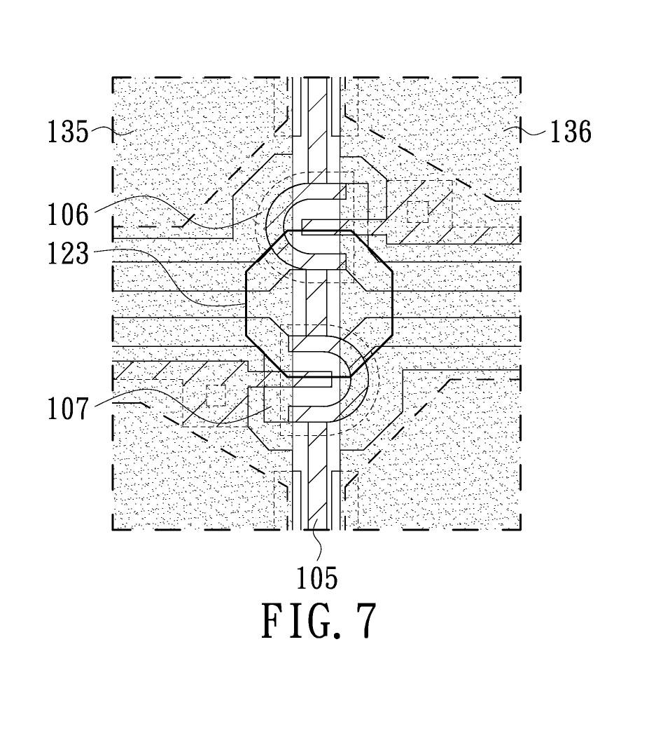

In a forth embodiment of this invention, another type of the spacer and the color filter layer structures of the Half Source Driver liquid crystal display are illustrated. As shown in FIG. 7, most structures of this embodiment are similar to those as described in FIG. 6 except that the color filter layers 135 and 136 are formed in stripe shapes. The stripe-shaped color filter layers 135 and 136 cover the light transmission area of pixels along the data line direction. The spacer 123 overlaps with parts of the stripe-shaped color filter layers 135 and 136 on the color filter substrate, and with both a part of the TFT 106 and a part of the TFT 107 on the array substrate in a top view to maintain the cell gap between the two substrates.

This invention can be performed in many different types LCD, such as the Fringe Field Switch type LCD, the Twisted Nematic type LCD, the Vertical Alignment type LCD, or the In-Plane Switch type LCD, etc. As long as there are two neighboring thin film transistors or spacer-supporting structures with non-linear edge, the spacer structure can be instructed by the embodiments of this invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A liquid crystal display device, comprising:
a first substrate;
a plurality of pixel units disposed above the first substrate, wherein each of the pixel units comprises a first gate line, a second gate line, a first thin film transistor electrically connected to the first gate line, and a second thin film transistor adjacent to the first thin film transistor and electrically connected to the second gate line;
a second substrate disposed opposite to the first substrate; and
a plurality of spacers interposed between the first and second substrates;
wherein at least one of the spacers overlaps with both the first thin film transistor and the second thin film transistor in a top view.

2. The liquid crystal display device according to claim 1, wherein at least one of the spacers partially or completely overlaps with the first thin film transistor and partially or completely overlaps with the second thin film transistor in the top view.

3. The liquid crystal display device according to claim 1, further comprising a first color filter layer, a second color filter layer, and a third color filter layer disposed above an inner surface of the second substrate, which faces to the first substrate, and corresponding to three of the pixel units, respectively; wherein each of the first, second and third color filter layers overlaps with a light transmitting area of the corresponding pixel unit in the top view.

4. The liquid crystal display device according to claim 3, wherein at least one of the spacers overlaps with two of the first, second, and third color filter layers in the top view.

5. The liquid crystal display device according to claim 1, wherein each of the pixel units comprises at least a first pixel, a second pixel, a third pixel, a fourth pixel, and a data line, and the data line is disposed above an inner surface of the first substrate, which faces to the second substrate, and provides a signal to each of the fist, second, third, and fourth pixels.

6. The liquid crystal display device according to claim 1, wherein each of the plurality of spacers is formed of a photoresist material.

7. The liquid crystal display device according to claim 1, further comprising a first light shielding layer disposed above an inner surface of the second substrate, which faces to the first substrate; wherein the first light shielding film overlaps with the first and second gate lines and the first and second thin film transistors in the top view.

8. The liquid crystal display device according to claim 7, wherein the first light shielding layer overlaps with at least a part of one of the spacers in the top view.

9. A liquid crystal display device, comprising:
a first substrate;
a first spacer-supporting structure with non-linear edge disposed above the first substrate, and comprising a multi-layered structure;
a second spacer-supporting structure with non-linear edge disposed above the first substrate and adjacent to the first spacer-supporting structure, and comprising a multi-layered structure;
a second substrate disposed opposite to the first substrate; and
a plurality of spacers interposed between the first and second substrates;
wherein at least one of the spacers overlaps with both the first spacer-supporting structure and the second spacer-supporting structure in a top view.

10. The liquid crystal display device according to claim 9, wherein at least one of the spacers partially or completely overlaps with the first spacer-supporting structure and partially or completely overlaps with the second spacer-supporting structure in the top view.

11. The liquid crystal display device according to claim 9, wherein the spacer-supporting structure with non-linear edge comprises a first conductive layer, a channel layer, a second conductive layer, and a passivation layer.

12. The liquid crystal display device according to claim 9, wherein each of the first and second spacer-supporting structures with non-linear edge comprises a thin film transistor.
